(19) United States
(12) Patent Application Publication
(10) Pub. No.: US 2014/0317511 A1
(43) Pub. Date: Oct. 23, 2014

(54) Systems and Methods for Generating Photographic Tours of Geographic Locations

(71) Applicant: GOOGLE Inc., (US)

(72) Inventors: Zhou Bailiang, Balgowlah (AU); Chase Hensel, San Francisco, CA (US)

(73) Assignee: GOOGLE Inc., Mountain View, CA (US)

(21) Appl. No.: 13/865,744

(22) Filed: Apr. 18, 2013

(51) Int. Cl. G06F 3/0484

(52) U.S. Cl. CPC G06F 3/04842
USPC 715/730

(57) ABSTRACT

Embodiments include a computer-implemented for generating a photographic tour of a geographic location. The method including receiving, from first and second users, first and second sets of photographic images associated with the geographic location, receiving, from the first user, a request to generate the photographic tour of the geographic location, providing the first and second sets of photographic images for display, the photographic images of the first and second sets of photographic images being user selectable for inclusion in the photographic tour of the geographic location, receiving user selection of at least one of the photographic images of the first set of photographic images received from the first user and at least one of the photographic images of the second set of photographic images received from the second user, generating the photographic tour of the geographic location using the selected photographic images.

### BACKGROUND OF THE INVENTION

1. Field of the Invention

Embodiments of this invention relate generally to presenting photographs and, more particularly, to generating photographic tours of geographic locations.

2. Description of the Related Art

During travel, people often take photographs of various things, such as points of interest. People can view photographs at later time to relive their experiences and share their experiences with other people. For example, a person that visits New York City may take photographs of Central Park, Times Square, the Brooklyn Bridge, the Statue of Liberty and so forth, and may share the photographs with friends and family to share their experience. With the advent of digital photographs, and their widely accepted use, users are now more likely to capture digital photographs using digital cameras (as opposed to the traditional photographs captured using a film type camera). Digital photographs are typically stored as electronic image files that can be shared electronically. For example, a person may take any number of digital photographs during their visit to New York City and share them with their friends and family, for example, by e-mailing them to specific persons, by uploading them to a social networking website for viewing by other people, or the like. The electronic format of digital photographs can provide almost endless possibilities for how photographs are stored, shared and displayed. For example, digital photographs can be stored in an electronic file folder that includes a set of electronic image files that can be opened one-by-one to view the photographs, or stored in a digital photo album that can be viewed as an electronic “slide show” of the photographs. An electronic slide show may automatically scroll through the digital photographs in combination with various special effects, such as graphical transitions from one digital photograph to the next.

Although the advent of digital photographs and the various techniques for storing and presenting them help users manage and share their photographs, users are typically limited to photographs that they personally captured. For example, when generating a digital photo album for New York City, a user may be limited to using the digital photographs they acquired while in New York City. As a result, users often lack a complete set of photographs. For example, a user may forget to take a particular photograph or a photograph may be of poor quality (e.g., out of focus). If the user took images of the Statue of Liberty from the front side of the Statue, but not from the back side of the Statue, for example, the user's photo album for the trip to New York may not include photographs of the back of the Statue of Liberty, resulting in an incomplete experience for the user when they want to view and share their photographs.

### SUMMARY OF THE INVENTION

Various embodiments of methods and apparatus for generating photographic tours of geographic locations are provided. In some embodiments, provided is a computer-implemented for generating a photographic tour of a geographic location. The method including receiving, from a first user, a first set of photographic images associated with the geographic location, receiving, from a second user, a second set of photographic images associated with the geographic location, receiving, from the first user, a request to generate the photographic tour of the geographic location, providing, by one or more processors, the first and second sets of photographic images for display via a graphical user interface, wherein the photographic images of the first and second sets of photographic images are user selectable for inclusion in the photographic tour of the geographic location, receiving, by the one or more processors, user selection of two or more of the photographic images of the first and second sets of images, wherein the two or more photographic images selected comprise at least one of the photographic images of the first set of photographic images received from the first user and at least one of the photographic images of the second set of photographic images received from the second user, generating, by the one or more processors, the photographic tour of the geographic location using the two or more photographic images selected such that the photographic tour of the geographic location comprises photographic images provided by a user other than the user from which the request to generate the photographic tour of the geographic location was received, and storing, in a photographic tour repository, the photographic tour of the geographic location.

In some embodiments, provided is a computer-implemented method that includes displaying, at a client device associated with a user, a map indicating a geographic location, receiving, from a server, data identifying a plurality of photographic images to which the user has access rights, the plurality of photographic images identified by the server as being associated with the geographic location, displaying, on the map, a plurality of graphical representations, each graphical representation corresponding to one of the photographic images, receiving input selecting a plurality of the graphical representations, and sending, by the client device, a request to the server to generate a photographic tour of the geographic location, the tour including the photographic images corresponding to the plurality of graphical representations selected.

In some embodiments, provided is a non-transitory computer readable medium comprising program instructions stored thereon that are executable by a processor to cause the following steps for generating a photographic tour of a geographic location: determining that a first set of photographic images administered by a first user are associated with the geographic location, defining a second set of photographic images, each photographic image of the second set being: (i) associated with the geographic location and (ii) an image to which the first user has been granted an access right, providing data usable to display a representation of the photographic images of the first and second sets of photographic images on a display device, receiving, data indicating a selection of two or more of the photographic images of the first and second sets of images, wherein the two or more photographic images selected includes at least one of the photographic images of the first set of photographic images and at least one of the photographic images of the second set of photographic images, and generating a photographic tour of the geographic location including the two or more photographic images.

### BRIEF DESCRIPTION OF THE DRAWINGS

FIG. 1 is a flowchart that illustrates a method of generating a photographic tour of a geographic location in accordance with one or more embodiments of the present technique.

FIG. 2 is a geographic map that illustrates exemplary photographs and respective geographic locations at which they were taken in accordance with one or more embodiments of the present technique.

FIG. 3 illustrates an exemplary display of a photograph selection interface for use in selecting photographs to be used in a photographic tour of a geographic location in accordance with one or more embodiments of the present technique.

FIG. 4 illustrates an exemplary display of a sequence selection interface for use in specifying a sequence for displaying the selected photographs in the photographic tour of a geographic location in accordance with one or more embodiments of the present technique.

FIG. 5 is a block diagram that illustrates a photographic tour environment in accordance with one or more embodiments of the present technique.

FIG. 6 is a block diagram that illustrates an exemplary computer system in accordance with one or more embodiments of the present technique.

### DETAILED DESCRIPTION

As discussed in more detail below, provided are systems and methods for generating photographic tours of geographic locations. A photographic tour may include a set of one or more photographic images (“photographs” or “photos”) of one or more geographic locations that can provide a user with a visual experience of the one or more geographic locations. In some instances, the geographic location that is the subject of the tour includes a point of interest (POI), such as a building, a bridge, a statute, a park, or other thing of interest. A photographic tour of a given geographic location may include a plurality of photographs taken from a number of different vantage points about the geographic location. Such photographs may be displayed to a user to provide a visual experience that is at least somewhat similar to what they would see if they actually visited the geographic location. A photographic tour of the Statue of Liberty, for example, may include a plurality of photographs of the Statue taken from a number of different vantage points around the Statue (e.g., the front, back and sides), and the photographs of the Statue can be displayed to a user such that they can have a visual experience somewhat similar to what they would see if they actually visited the Statue of Liberty. In some instances, a photographic tour may be animated to enhance the visual experience. A photographic tour of the Statue of Liberty that includes photographs taken from the front, back, right and left sides of the Statue, for example, may include displaying the photographs of the front, right, back and left sides of the Statue in sequence, one-after-the-other, to provide a visual experience that replicates walking around the Statue of Liberty. In some instances, the photographic tour includes additional effects to enhance the user experience. For example, an animated photographic tour of the Statue of Liberty may fade in-and-out between consecutive photographs in the display sequence to provide visually appealing transition from one photograph to the next, e.g., closely replicating the experience of walking around the Statue of Liberty.

In some embodiments, a photographic tour includes photographs for more than one geographic location (i.e., tours for multiple geographic locations). For example, a photographic tour for a user's visit to New York City may include sets of photographs for each of Central Park, Times Square, the Brooklyn Bridge, the Statue of Liberty and so forth. The photographic tour may include, for example, displaying the images of Central Park in sequence, followed by displaying images of Times Square in sequence, and so forth. The tour may, thus, include a photographic story of the user's visit to New York City. The sequence for displaying the photographs may be user selected. For example, the user may be provided an opportunity to select photographs to be displayed in their photographic tour, and specify which of the photographs is displayed first, second, third, and so forth. In the case of a photographic tour of the Statue of Liberty that includes photographs of the front, back, right and left sides of the Statue, for example, the user can select all four of the images, specifying that the photographs are displayed in the order of front side, right side, back side and left side.

In some embodiments, a photographic tour is constructed using a user's own photographs. For example, the user may take the four photographs of the front, back, left and right sides of the statue of liberty using their digital camera, the four photographs may be uploaded to the user's account, and the user may, then, use the four photographs in their user account to create a photographic tour of the Statue of Liberty that includes the four photos taken by the user. In some instances, a photographic tour is constructed using other user's photographs. For example, if the user takes photographs of the front and left sides of the Statue of Liberty using their digital camera, but forgets to capture an image of the back and right sides of the Statue of Liberty, the user can upload the two photographs they did take to their account, locate photographs of the back and right sides that were taken and shared by other users, and construct a photographic tour of the Statue of Liberty using their two images of the Statue and the two images of the Statue taken by other users. That is, the user can “borrow” photographs taken by other users to construct a photographic tour of a geographic location. Such “borrowing” may be especially useful where the user wants to create a photographic tour of a geographic location, but they did not take enough photographs of the geographic location (e.g., the user forgot to take a photograph of the right and back side of the Statute of Liberty) and/or they want to supplement the photographic tour with additional photos to help enhance the visual experience (e.g., the user took photographs from all four sides of the Statute of Liberty, but they need additional photographs to fill in the gaps, or replace photographs of poor quality). Accordingly, the “borrowing” of photographs may enable a user to generate extensive and visually appealing photographic tours of geographic locations without having to capture every picture in the tour themselves.

In some embodiments, photographs to be “borrowed” from other users for use in constructing a photographic tour of a geographic location are identified based on their association with the geographic location. For example, if the user indicates that they are constructing a photographic tour of the Statue of Liberty, the user may be presented with other user's photographs having metadata (e.g., a name, description, or the like) that includes the term “Statue of Liberty”, and/or being associated with a geographic location that is proximate to (e.g., within a threshold distance of) the Statue of Liberty. Thus, for example, where ten photographs taken by other users have metadata including the normalized phrase “statue_of_liberty” and/or have a geotag indicating that were acquired within one-hundred meters of the Statue of Liberty, the user may be presented with these ten images for use in generating his/her photographic tour of the Statue of Liberty.

In some embodiments, the user's photographs that are presented for use in constructing a photographic tour of a geographic location are identified based on their association with the geographic location. For example, if the user indicates that they are constructing a photographic tour of the Statue of Liberty, the user may be presented with their photographs that have metadata (e.g., a name, description, or the like) that includes the term “Statue of Liberty”, and/or being associated with a geographic location that is proximate to (e.g., within a threshold distance of) the Statue of Liberty. Thus, for example, where the user took one-hundred photographs while visiting New Your City, but only four of those photographs have metadata including the normalized phrase “statue_of_liberty” and/or have a geotag indicating that were acquired within one-hundred meters of the Statue of Liberty, the user may be presented with these four images for use in generating his/her photographic tour of the Statue of Liberty. In some embodiments, the user may not be limited to the set of photographs identified, and may search through their photographs as well as the photographs taken by other users to locate additional photographs for use in construing their photographic tour. In some embodiments, a user may construct a photographic tour of a geographic location using only borrowed photographs. For example, after visiting the Statue of Liberty, the user may not have taken and photographs while there, or may not like the photographs they took while there and may select images shared by other users to generate a photographic tour of the Statue of Liberty.

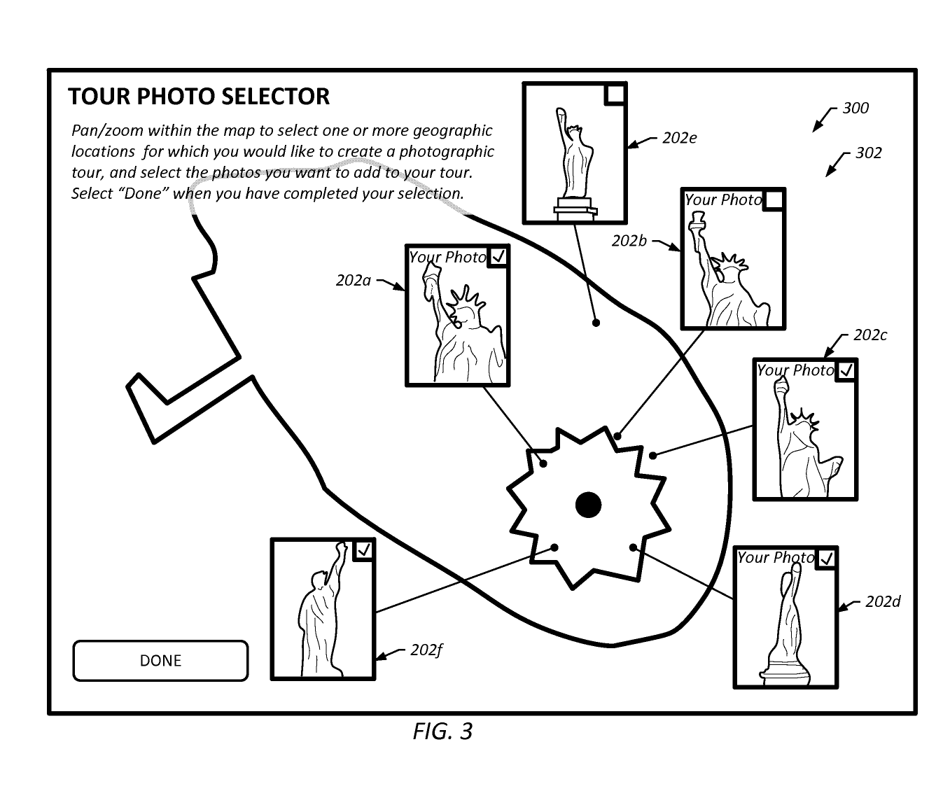

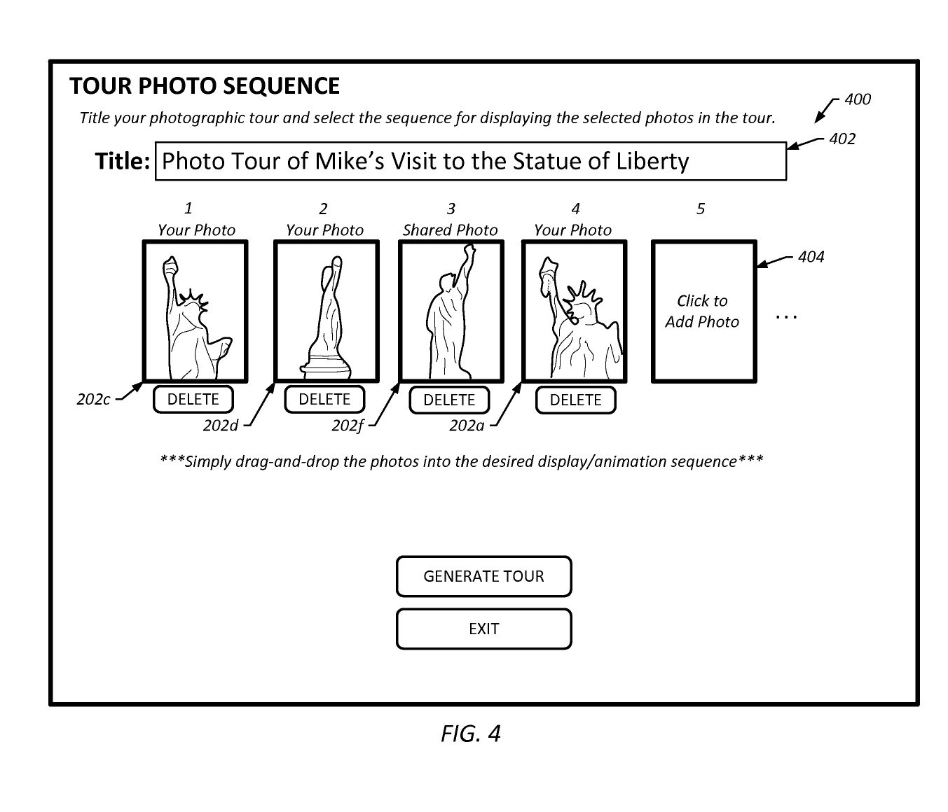

In some embodiments, a user interface for generating a photographic tour of a geographic location includes display of a geographic map of an area/region including the geographic location, along with the photographs identified for use in constructing a photographic tour overlaid on the map. For example, where four of the user's photographs and two other users' photographs have been identified for user in constructing a photographic tour of the Statue of Liberty, the interface for constructing the photographic tour may include a map of Liberty Island, along with thumbnails for of the six photographs overlaid on the map. (See, e.g., FIG. 3). In some embodiments, the photographs are associated with locations on the map. For example, each thumbnail may be overlaid at or near a location where the corresponding photograph was taken and/or a leader may be provided that points to the location where the corresponding photograph was taken. The user may select which of the displayed photos are to be added to the photographic tour for the geographic location. Once the user has selected the photographs to be included in the photographic tour, the user may be provided an opportunity to specify a sequence for displaying the photographs in the photographic tour. For example, where the user selects four, of the six photographs from the map of Liberty Island (e.g., including the three photographs they took, along with one photograph taken by another user), the user may be provided with an opportunity to specify which photograph is displayed first, second, third and fourth. (See, e.g., FIG. 4). The resulting photographic tour may include an animation that includes displaying the selected photographs in the specified order. For example, the photographic tour of the Statue of Liberty may include animation that includes the sequential display of the front side photograph taken by the user, the right side photograph taken by the user, a back side photograph taken by the other user and, finally, the left side photograph taken by the user. Such a photographic tour may provide a visual experience somewhat similar to what a person would see if they walked around the Statue of Liberty. The photographic tour can be saved for later viewing. In some embodiments, the photographic tour is shared with other users such that they can view the photographic tour. For example, the user may post the photographic tour on a social networking site for viewing by their social network friends, and/or they may e-mail the photographic tour to their friends and family so they can view the photographic tour of the Statue of Liberty.

It should be noted that users are provided with the option to share or not share their information, including their photographs and/or photographic tours. For example, a user may be required to consent to the collection and/or sharing of their photographs prior to the photographs being uploaded to their account and/or being shared with other users. In some instances, users can select what, if any, level of access other users have to their photographs. For example, a user may specify in their account preferences that their photographs and/or their photographic tours are to be shared only with friends on their social network. Users have the ability to revoke their consent and/or modify the level of access. For example, a user may simply log-in to their account and “turn-off” (i.e., disable) the sharing of their photographs and/or their photographic tours, and/or change the level of access to their photographs and/or their photographic tours at any time. Accordingly, users may maintain access control over their photographs. A user may be an “administrator” of his/her own photographs. An administrator may have the authority to grant access rights to other users (e.g., to grant other users rights to view and/or borrow their photographs and/or photographic tours).

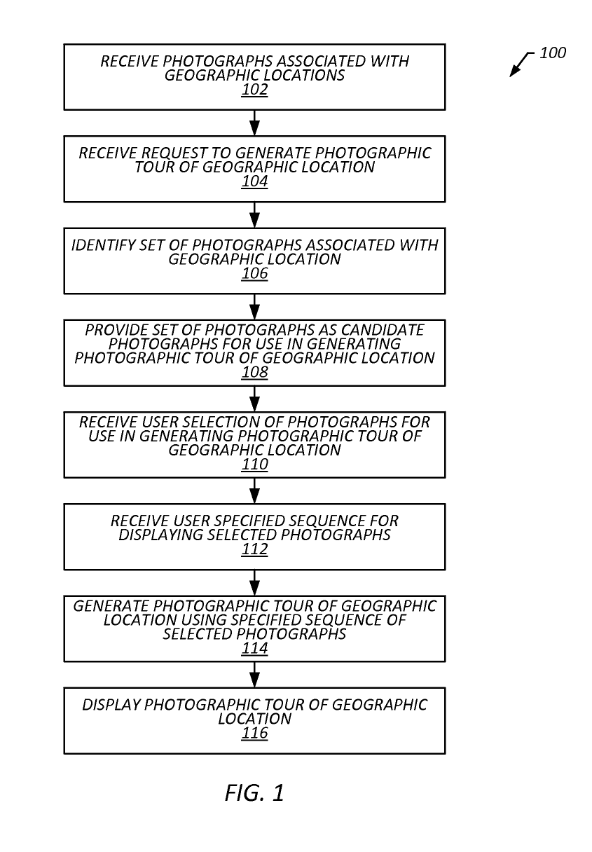

FIG. 1 is a flowchart that illustrates a method of generating a photographic tour of a geographic location in accordance with one or more embodiments of the present technique. Method 100 generally includes receiving photographs associated with geographic locations, receiving a request to generate a photographic tour of a geographic location, identifying a set of photographs associated with the geographic location, providing a set of candidate photographs for use in generating the photographic tour of the geographic location, receiving user selection of the candidate photos to be used in generating the photographic tour of the geographic location, receiving a user specified sequence of the selected photographs, generating the photographic tour of the geographic location using the selected photographs and the specified sequence, and presenting the photographic tour of the geographic location.

Method 100 may include receiving photographs associated with geographic locations (block 102). In some embodiments, receiving photographs associated with geographic locations includes receiving photographs associated with any number of geographic locations from any number of different users. For example, thousands of users may upload photos from around the world and consent to sharing them with other users. Users that have taken photos in New York City, for example, may upload photos of various points of interest in New York City, such as Central Park, Times Square, the Brooklyn Bridge, the Statue of Liberty and so forth, into their user accounts. The photographs uploaded by a user may be stored (e.g., as a digital image file) in association with the user's account. Users may have the option to add and/or delete photographs from their account. Thus, overtime users' accounts may include a personal photo album for the users. For example, after visiting New York and Paris, Mike Smith may upload the photographs he took while in New York and Paris, respectively, thereby generating a personal electronic photo album for Mike that includes photographs from his trips to New York and Paris. Similar personal photo albums may be created by any number of users to generate any number of personal photo albums. In some embodiments, users may share some or all of the photos in their personal photo albums such that they can be viewed by other users and/or borrowed by other users for use in generating photographic tours of geographic locations.

Users may be provided with the option to share some or all of the photographs in their accounts with other users. That is, a user may be required to consent to sharing photographs before they are made available to other users. For example, a user may modify their account preferences to “allow sharing of all photographs”, thereby allowing other users to access (e.g., view and/or borrow) all of the photographs associated with their account. In some embodiments, users have the option to specifically select which photographs are shared and which photographs are not shared. For example, a user may modify their account preferences to “allow sharing of photographs” and may select certain photographs to share or not share with other users, thereby allowing other users to access only those photographs selected for sharing. In some embodiments, users can control what users have access to their shared photographs. For example, a user may modify their account preferences to “share with everyone” to allow all other users to access their shared photographs, to “share with friends” to allow only users identified as friends of the user (e.g., social network friends) to access their shared photographs, and/or to “share with individuals” to select specific individuals that are allowed to access their shared photographs. A user may modify their account preferences to “not allow sharing of any photographs”, thereby preventing other users from accessing any of the photographs associated with their account. Users may have the option to revoke their consent to share images and/or to modify the level of sharing at any time. For example, a user can simply login to their account and modify their preferences to limit what photographs, if any, are shared and who they are shared with. Accordingly, users may maintain access control over their photographs. For example, Mike Smith may be an “administrator” of the photographs associated with his account and, thus, may have the authority to grant access rights to other users (e.g., to grant other users rights to view and/or borrow his photographs and/or photographic tours).

Method 100 may include receiving a request to generate a photographic tour of a geolocation (block 104). In some embodiments, receiving a request to generate a photographic tour of a geolocation includes receiving a request from a user to generate a photographic tour for one or more geographic locations. For example, Mike Smith may login to his account, select an option to generate a photographic tour, and specify the location of the Statue of Liberty. In some embodiments, the geographic location may be specified via a point of interest search. For example, upon selecting the option to generate a photographic tour, Mike Smith may be presented with a list of points of interest and may select the geographic location of “Statue of Liberty”, or he may submit a POI search query for “Statue of Liberty” to identify the geographic location. In some embodiments, the geographic location may be specified via interaction with a geographic map. For example, upon selecting the option to generate a photographic tour, Mike Smith may be presented with a geographic map, and he may pan/zoom within the map to navigate to and select the geographic location of “Statue of Liberty”. Such a map-based selection of the geographic location may be advantageous where the POI is not well-known and, thus, may not be present in a database of points of interest.

Method 100 may include identifying a set of photographs associated with the geographic location (block 106). In some embodiments, identifying a set of photographs associated with the geographic location includes identifying the user's photographs and/or other photographs that are shared with the user and associated with the geographic location. For example, in response to Mike Smith identifying the Statue of Liberty as the subject of the photographic tour, identifying a set of photographs associated with the Statue of Liberty may include identifying which, if any of Mike's photographs are associated with the Statue of Liberty, and/or which, if any, of the photographs shared with Mike by other users are associated with the Statue of Liberty. In some embodiments, a photograph is determined to be associated with a geographic location based on metadata associated with the photograph. A photograph may be identified as being associated with a geographic location if, for example, a name/title and/or description of the photograph includes the name of the geographic location. For example, it may be determined that a photograph including the normalized phrase of “statue_of_liberty” in its name/title and/or description is associated with the Statue of Liberty. A photograph may be identified as being associated with a geographic location if, for example, a geotag of the photograph corresponds to a geographic location that is within a threshold distance (e.g., one-hundred meters) of the geographic location. For example, it may be determined that a photograph including a geotag indicative of a location about fifty meters from the location of the Statue of Liberty is associated with the Statue of Liberty based on its location being within one-hundred meters of the Statue of Liberty. Although one-hundred meters is used for the purpose of illustration, embodiments may include any suitable threshold distance (e.g., one kilometer). A geotag may include geographic identification metadata, such as geographic coordinates (e.g., latitude and longitude coordinates) indicative of a location where the photograph was taken. Geotag data may be generated using position data acquired from an integrated positioning device of the camera. For example, where a user captures a photograph using an GPS (global positioning system) enabled camera phone, to GPS chip of the phone may be used to determine the geographic coordinates of the phone at or near the time the photograph is captured, and the digital image/photograph file may be geotagged with the geographic coordinates (e.g., the geographic coordinates may be added to the metadata of the digital image/photograph file).

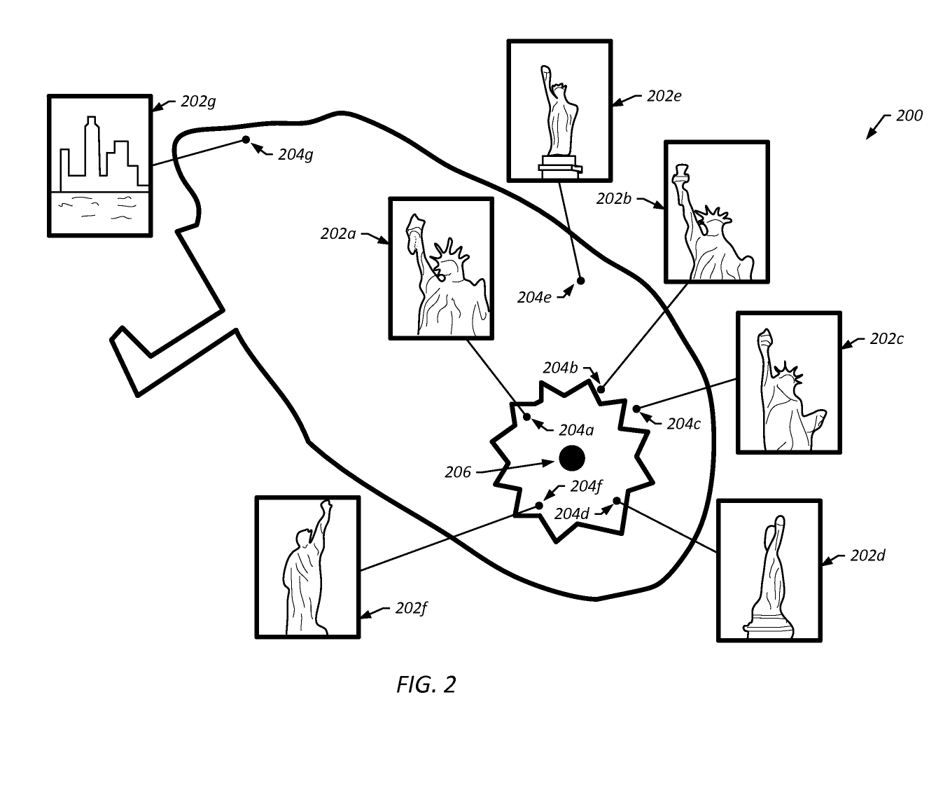

FIG. 2 is a geographic map 200 that illustrates exemplary photographs 202a-202g and the respective geographic locations 204a-204g at which they were taken. Map 200 may include a map of Liberty Island, including a geographic location 206 of the Statue of Liberty. Photos 202a-202d may include photographs taken by Mike Smith (and uploaded to his account) that are identified as being associated with the Statue of Liberty. Each of photographs 202a-202d may include, for example, the normalized phrase of “statue_of_liberty” in its name/title and/or description, and/or may include a geotag indicative of their respective locations 202a-202d being within one-hundred meters of the Statue of Liberty. Photographs 202a-202d may depict the left side, left-front side, front side and right side, respectively, of the Statue of Liberty taken by Mike Smith while on Liberty Island. Photograph 202g may include a photograph of the New York City skyline taken by Mike Smith while on Liberty Island. Photograph 202g may not be associated with the Statue of Liberty based at least in part on its name/title and/or description not corresponding to the Statue of Liberty, and/or its location 204g being more than one-hundred meters from the location of the Statue of Liberty. Photos 202e and 202f may include photographs taken by Jane Doe (and uploaded to her account). Photos 202e and 202f may be shared with Mike Smith by Jane Doe. Photos 202e and 202f may be identified as being associated with the Statue of Liberty. Each of photographs 202e and 202f may include, for example, the normalized phrase of “statue_of_liberty” in its name/title and/or description and/or may include a geotag indicative of their respective locations 204e and 204f being within one-hundred meters of the location of the Statue of Liberty.

Method 100 may include providing the identified set of photographs as candidate images for use in generating the photographic tour of the geographic location (block 108). In some embodiments, providing the set of photographs as candidate images for use in generating the photographic tour of the geographic location includes presenting the user with a graphical user interface that allows them to select which, if any, of the set of photographs are to be included in the photographic tour of the geographic location. FIG. 3 illustrates an exemplary display of a photograph selection interface 300 for use in selecting photographs to be used in generating a photographic tour of the Statue of Liberty. Photograph selection interface 300 may be displayed to the user in response to the user selecting a geographic location for the photographic tour. For example, photograph selection interface 300 may be served and displayed to Mike Smith in response to his selection of the Statue of Liberty as the subject of the photographic tour. Photograph selection interface 300 includes a map 302 of a region including the Statue of Liberty. Map 302 includes thumbnails depicting the images 202a-202f identified as being associated with the Statue of Liberty. Each of the thumbnails of the images associated with Mike Smith's account (i.e., images 202a-202d) includes the annotation “Your Photo”, indicating that each of these photographs are associated with Mike Smith's account. Such annotations may assist a user with distinguishing the photographs that he took (or that are otherwise associated with his account) from the shared photographs that are borrowed from other user's accounts.

To select photographs for use in generating the photographic tour of the Statue of Liberty, the user can simply “check” the box in the upper-right-hand corner of the respective thumbnail. In the illustrated embodiment, for example, Mike Smith has selected to use images 202a, 202c 202d, and 202f. Upon making his selection, Mike Smith may simply select the “DONE” button. In some embodiments, a photograph selection interface may employ a client (browser) side script, e.g., a JavaScript to select the photographs.

Method 100 may include receiving a user specified sequence for displaying the selected photographs (block 112). In some embodiments, receiving a user specified sequence for displaying the selected photographs includes presenting the user with a graphical user interface that allows them to specify a sequence for displaying the selected images. FIG. 4 illustrates an exemplary display of a sequence selection interface 400 for use in specifying a sequence for displaying the selected photographs 202a, 202d, 202d and 202f in the photographic tour of the Statue of Liberty. Sequence selection interface 400 includes a field 402 for entering a title/name of the photographic tour (e.g., “Photo Tour of Mike's Visit to the Statue of Liberty”). To add a photograph to the tour, a user can simply select box 404, which may cause navigation back to a photograph selection interface similar to that of FIG. 3. To delete/remove a selected photograph from the geographic tour, a user can simply select the “DELETE” button under the corresponding photograph. To specify the sequence in which the photographs are to be displayed in the photographic tour, the user may simply drag-and-drop the thumbnails of the photographs into a desired sequence. A photographic tour of the Statue of Liberty may be generated using the sequence specified in the sequence selection interface 400 (block 114) in response the user selecting the “GENERATE TOUR” button. Generation of the photographic tour may employ tween animation to stitch the photographs together such that they can be viewed as an animation. A resulting photographic tour of the Statue of Liberty using the illustrated sequence may include, for example, display of image 202c, followed by display of image 202d, followed by display of image 202f, and finally the display of image 202a. The generated tour may be stored in association with the user's account. For example, the photographic tour of the Statue of Liberty may be stored in association with Mike Smith's account.

Method 100 may include displaying the photographic tour of the geographic location (block 116). In some embodiments, displaying the photographic tour of the geographic location includes rendering the photographic tour of the geographic location on a graphical user interface. For example, Mike Smith may access his account and open the photographic tour of the Statue of Liberty to view it on a display device. The displayed photographic tour of the Statue of Liberty may include a visual animation that includes the sequential display of the front side photograph 202c taken by Mike Smith, the right side photograph 202d taken by Mike Smith, the back side photograph 202f borrowed from Jane Doe and, finally, the left side photograph 202a taken by Mike Smith. Such a photographic tour may provide a visual experience somewhat similar to what a person would see if they walked around the Statue of Liberty. In some embodiments, the photographic tour may be shared with other users. For example, the Mike Smith may post the photographic tour of the Statue of Liberty on his social networking webpage for viewing by his friends or other users on the social network, and/or he may e-mail the photographic tour to his friends and family so they can view the photographic tour of the Statue of Liberty.

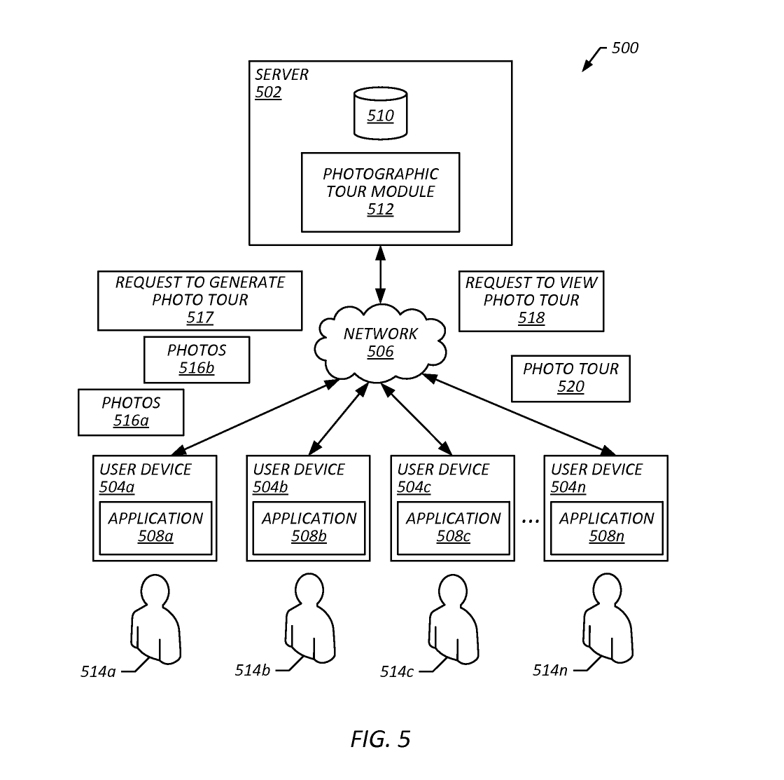

Method 100 is an exemplary embodiment of a method that may be employed in accordance with the techniques described herein. Method 100 may be modified to facilitate variations of its implementations and uses. Method 100 may be implemented in software, hardware, or a combination thereof. Some or all of method 100 may be implemented by one or more of the modules/applications described herein, such as photographic tour module 512 and/or application 508 depicted and described in more detail below with regard to FIG. 5. The order of the steps of method 100 may be changed, and various elements may be added, reordered, combined, omitted, modified, etc.

FIG. 5 is a block diagram that illustrates a photographic tour environment 500. Environment 500 includes a server 502 and mobile user devices 504a-504n (collectively referred to as “devices” 504) communicatively coupled via a network 506. Network 506 may include an electronic communications network, such as the Internet, a local area network (LAN), a wide area (WAN), a cellular communications network or the like. Network 506 may include a single network or combination of networks.

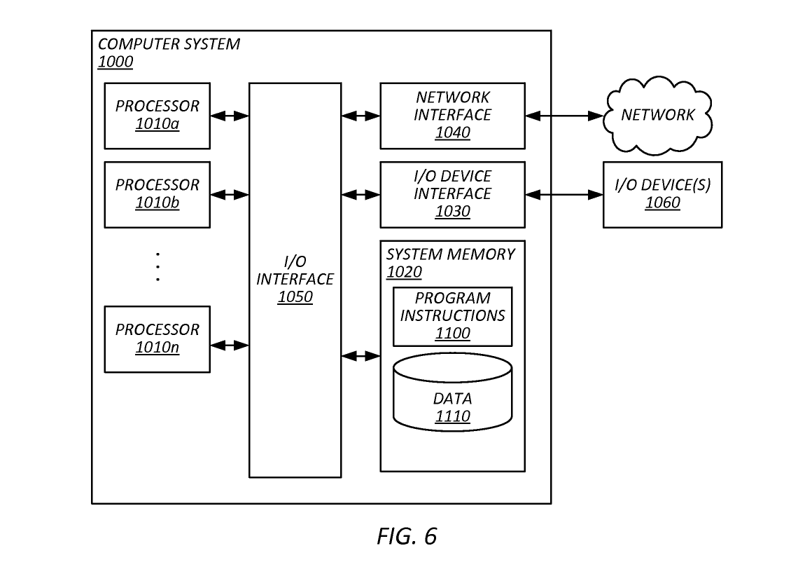

Devices 504 may include any variety of mobile electronic devices. For example, devices 504 may include laptops, tablet computers, cellular phones, personal digital assistants (PDAs), digital cameras, or the like. In some embodiments, devices 504 include various input/output (I/O) interfaces, such as a graphical user interface (e.g., a display screen), an image acquisition device (e.g., a camera), an audible output user interface (e.g., a speaker), an audible input user interface (e.g., a microphone), a keyboard, a pointer/selection device (e.g., a mouse, a trackball, a touchpad, a touchscreen, a stylus, etc.), a printer, or the like. In some embodiments, devices 504 include general computing components and/or embedded systems optimized with specific components for performing specific tasks. Devices 504 may include applications 508a-508n (collectively referred to herein as “applications” 508). Applications 508 may include one or more modules having program instructions that are executable by a computer system to perform some or all of the functionality described herein with regard to the respective devices 504. For example, applications 508 may include program instructions that are executable by a computer system to perform some or all of the steps of method 100. In some embodiments, devices 504 include a computer system similar to that of computer system 1000 described below with regard to at least FIG. 6.

Server 502 may include a network entity that serves requests by client entities. For example, server 502 may serve requests by devices 504. In some embodiments, server 502 hosts a content site, such as a website, a file transfer protocol (FTP) site, an Internet search website or other source of network content. In some embodiments, server 502 includes an image server for collecting storing and serving photographic images and/or photographic tours. In some embodiments, server 502 includes or otherwise has access to data store 510. Data store 510 may include a database or similar data repository. Data store 510 may include an image repository for storing photographic images and/or photographic tours.

In some embodiments, server 502 includes a photographic tour module 512. Module 512 may include program instructions that are executable by a computer system to perform some or all of the functionality described herein with regard to server 502. Module 512 may include program instructions that are executable by a computer system to perform some or all of the steps of method 100. In some embodiments, server 502 includes a computer system similar to that of computer system 1000 described below with regard to at least FIG. 6. Although server 502 is represented by a single box in FIG. 5, server 502 may include a single server (or similar system), or a plurality of servers (and/or similar systems). For example, server 502 may include a plurality of different servers (and/or similar systems) that are employed individually or in combination to perform some or all of the functionality described herein with regard to server 502.

In some embodiments environment 500 is used to employ techniques described herein (e.g., the steps of method 100). For example, user 514a (e.g., Mike Smith) may submit a set of photographic images (“photos”) 516a (e.g., photos 202a-202d) to server 502 using device 508a and user 514b (e.g., Jane Doe) may submit photos 516b (e.g., photos 202e and 202f) to server 502 using device 508b (e.g., as discussed with regard to block 102). Server 502 may store photos 516a and 516b in datastore 510 in association the respective accounts of users 516a and 516b. Users 516a and 516b may set their account preferences to enable sharing of some or all of the photos associated with their accounts. For example, user 516b may change his/her account setting to share photos 516b with user 514a. User 514a may submit, to server 502, a request 517 to generate a photographic tour for a given geographic location (e.g., the Statue of Liberty) (e.g., as discussed with regard to block 104). Server 502 may identify a set of photographs (e.g., photos 202a-202f) associated with the geographic location (e.g., as discussed with regard to block 106). Server 502 may provide the set of photographs as candidate photographs for use in generating the photographic tour of the geographic location (e.g., as discussed with regard to block 108). Server 502 may receive user selection of the photographs (e.g., selection of photos 202a, 202c, 202d and 202f) for use in generating the photographic tour of the geographic location (e.g., as discussed with regard to block 110), and a user specified sequence for displaying selected photographs (e.g., as discussed with regard to block 112). Server 502 may then generate a photographic tour (“photo tour”) 520 of the geographic location using the specified sequence of the selected photographs (e.g., as discussed with regard to block 114). Server may store photographic tour 520 in datastore 510 in association with the account of user 514a. Server 520 may provide for the display of photographic tour 520 to one or more users (e.g., as discussed with regard to block 116). For example, if user 514a has consented to sharing photographic tour 520 with user 514c, server 502 may serve photographic tour 520 for display on device 508c (via application 508c) in response to receiving a request 518 from user 514a/device 508a to view the photo tour 520.

Exemplary Computer System

FIG. 6 is a block diagram that illustrates an exemplary computer system 1000. Various portions of systems and methods described herein, may include or be executed on one or more computer systems similar to system 1000. For example, server 502 and/or user devices 504 may include a configuration similar to at least a portion of computer system 1000. Further, methods/processes/modules described herein (e.g., module 512 and/or applications 508) may be executed by one or more processing systems similar to that of computer system 1000.

Computer system 1000 may include one or more processors (e.g., processors 1010a-1010n) coupled to system memory 1020, an input/output I/O device interface 1030 and a network interface 1040 via an input/output (I/O) interface 1050. A processor may include a single processor device and/or a plurality of processor devices (e.g., distributed processors). A processor may be any suitable processor capable of executing/performing instructions. A processor may include a central processing unit (CPU) that carries out program instructions to perform the basic arithmetical, logical, and input/output operations of computer system 1000. A processor may include code (e.g., processor firmware, a protocol stack, a database management system, an operating system, or a combination thereof) that creates an execution environment for program instructions. A processor may include a programmable processor. A processor may include general and/or special purpose microprocessors. A processor may receive instructions and data from a memory (e.g., system memory 1020). Computer system 1000 may be a uni-processor system including one processor (e.g., processor 1010a), or a multi-processor system including any number of suitable processors (e.g., 1010a-1010n). Multiple processors may be employed to provide for parallel and/or sequential execution of one or more portions of the techniques described herein. Processes and logic flows described herein may be performed by one or more programmable processors executing one or more computer programs to perform functions by operating on input data and generating corresponding output. Processes and logic flows described herein may be performed by, and apparatus can also be implemented as, special purpose logic circuitry, e.g., an FPGA (field programmable gate array) or an ASIC (application specific integrated circuit). Computer system 1000 may include a computer system employing a plurality of computer systems (e.g., distributed computer systems) to implement various processing functions.

I/O device interface 1030 may provide an interface for connection of one or more I/O devices 1060 to computer system 1000. I/O devices may include any device that provides for receiving input (e.g., from a user) and/or providing output (e.g., to a user). I/O devices 1060 may include, for example, graphical user interface displays (e.g., a cathode ray tube (CRT) or liquid crystal display (LCD) monitor), pointing devices (e.g., a computer mouse or trackball), keyboards, keypads, touchpads, scanning devices, voice recognition devices, gesture recognition devices, printers, audio speakers, microphones, cameras, or the like. I/O devices 1060 may be connected to computer system 1000 through a wired or wireless connection. I/O devices 1060 may be connected to computer system 1000 from a remote location. I/O devices 1060 located on remote computer system, for example, may be connected to computer system 1000 via a network and network interface 1040.

Network interface 1040 may include a network adapter that provides for connection of computer system 1000 to a network. Network interface may 1040 may facilitate data exchange between computer system 1000 and other devices connected to the network. Network interface 1040 may support wired or wireless communication. The network may include an electronic communication network, such as the Internet, a local area network (LAN), a wide area (WAN), a cellular communications network or the like.

System memory 1020 may be configured to store program instructions 1100 and/or data 1110. Program instructions 1100 may be executable by a processor (e.g., one or more of processors 1010a-1010n) to implement one or more embodiments of the present technique. Instructions 1100 may include modules of computer program instructions for implementing one or more techniques described herein with regard to various processing modules. Program instructions may include a computer program (also known as a program, software, software application, script, or code). A computer program may be written in any form of programming language, including compiled or interpreted languages, or declarative/procedural languages. A computer program may include a unit suitable for use in a computing environment, including as a stand-alone program, a module, a component, a subroutine. A computer program may or may not correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one or more computer processors located locally at one site or distributed across multiple remote sites and interconnected by a communication network.

System memory 1020 may include a tangible program carrier. A tangible program carrier may include a propagated signal and/or a non-transitory computer readable storage medium. A propagated signal may include an artificially generated signal (e.g., a machine generated electrical, optical, or electromagnetic signal) having encoded information embedded therein. The propagated signal may be transmitted by a suitable transmitter device to and/or received by a suitable receiver device. A non-transitory computer readable storage medium may include a machine readable storage device, a machine readable storage substrate, a memory device, or any combination thereof, or the like. Non-transitory computer readable storage medium may include non-volatile memory (e.g., flash memory, ROM, PROM, EPROM, EEPROM memory), volatile memory (e.g., random access memory (RAM), static random access memory (SRAM), synchronous dynamic RAM (SDRAM)), bulk storage memory (e.g., CD-ROM and/or DVD-ROM, hard-drives), or the like. System memory 1020 may include a non-transitory computer readable storage medium having program instructions stored thereon that are executable by a computer processor (e.g., one or more of processors 1010a-1010n) to cause some or all of the subject matter and the functional operations described herein. A memory (e.g., system memory 1020) may include a single memory device and/or a plurality of memory devices (e.g., distributed memory devices).

I/O interface 1050 may be configured to coordinate I/O traffic between processors 1010a-1010n, system memory 1020, network interface 1040, I/O devices 1060 and/or other peripheral devices. I/O interface 1050 may perform protocol, timing or other data transformations to convert data signals from one component (e.g., system memory 1020) into a format suitable for use by another component (e.g., processors 1010a-1010n). I/O interface 1050 may include support for devices attached through various types of peripheral buses, such as a variant of the Peripheral Component Interconnect (PCI) bus standard or the Universal Serial Bus (USB) standard.

Embodiments of the techniques described herein may be implemented using a single instance of computer system 1000, or multiple computer systems 1000 configured to host different portions or instances of embodiments. Multiple computer systems 1000 may provide for parallel or sequential processing/execution of one or more portions of the techniques described herein.

Those skilled in the art will appreciate that computer system 1000 is merely illustrative and is not intended to limit the scope of the techniques described herein. Computer system 1000 may include any combination of devices and/or software that may perform or otherwise provide for the performance of the techniques described herein. For example, computer system 1000 may include a desktop computer, a laptop computer, a tablet computer, a server device, a client device, a mobile telephone, a personal digital assistant (PDA), a mobile audio or video player, a game console, a Global Positioning System (GPS), or the like. Computer system 1000 may also be connected to other devices that are not illustrated, or may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 1000 may be transmitted to computer system 1000 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium. Accordingly, the present invention may be practiced with other computer system configurations.

It should be understood that the description and the drawings are not intended to limit the invention to the particular form disclosed, but to the contrary, the intention is to cover all modifications, equivalents, and alternatives falling within the spirit and scope of the present invention as defined by the appended claims. Further modifications and alternative embodiments of various aspects of the invention will be apparent to those skilled in the art in view of this description. Accordingly, this description and the drawings are to be construed as illustrative only and are for the purpose of teaching those skilled in the art the general manner of carrying out the invention. It is to be understood that the forms of the invention shown and described herein are to be taken as examples of embodiments. Elements and materials may be substituted for those illustrated and described herein, parts and processes may be reversed or omitted, and certain features of the invention may be utilized independently, all as would be apparent to one skilled in the art after having the benefit of this description of the invention. Changes may be made in the elements described herein without departing from the spirit and scope of the invention as described in the following claims. Headings used herein are for organizational purposes only and are not meant to be used to limit the scope of the description.

As used throughout this application, the word “may” is used in a permissive sense (i.e., meaning having the potential to), rather than the mandatory sense (i.e., meaning must). The words “include”, “including”, and “includes” mean including, but not limited to. As used throughout this application, the singular forms “a”, “an” and “the” include plural referents unless the content clearly indicates otherwise. Thus, for example, reference to “an element” may include a combination of two or more elements. Unless specifically stated otherwise, as apparent from the discussion, it is appreciated that throughout this specification discussions utilizing terms such as “processing”, “computing”, “calculating”, “determining” or the like refer to actions or processes of a specific apparatus, such as a special purpose computer or a similar special purpose electronic processing/computing device. In the context of this specification, a special purpose computer or a similar special purpose electronic processing/computing device is capable of manipulating or transforming signals, typically represented as physical electronic or magnetic quantities within memories, registers, or other information storage devices, transmission devices, or display devices of the special purpose computer or similar special purpose electronic processing/computing device.

What is claimed is:

1. A computer-implemented method for generating a photographic tour of a geographic location, the method comprising:
receiving, from a first user, a first set of photographic images associated with the geographic location;
receiving, from a second user, a second set of photographic images associated with the geographic location;
receiving, from the first user, a request to generate the photographic tour of the geographic location;
providing, by one or more processors, the first and second sets of photographic images for display via a graphical user interface, wherein the photographic images of the first and second sets of photographic images are user selectable for inclusion in the photographic tour of the geographic location;
receiving, by the one or more processors, user selection of two or more of the photographic images of the first and second sets of images, wherein the two or more photographic images selected comprise at least one of the photographic images of the first set of photographic images received from the first user and at least one of the photographic images of the second set of photographic images received from the second user;
generating, by the one or more processors, the photographic tour of the geographic location using the two or more photographic images selected such that the photographic tour of the geographic location comprises at least one photographic image provided by a user other than the user from which the request to generate the photographic tour of the geographic location was received; and
storing, in a photographic tour repository, the photographic tour of the geographic location.

2. The method of claim 1, wherein the geographic location comprises a geographic point of interest.

3. The method of claim 1, wherein the photographic tour of the geographic location comprises photographic images of the geographic location taken from different perspectives.

4. The method of claim 1, further comprising, receiving from the user, a specified sequence for displaying the two or more photographic images selected, wherein the photographic tour of the geographic location comprises an animated display of the two or more photographic images selected in accordance with the specified sequence.

5. The method of claim 1, further comprising identifying the first and second sets of photographic images as being associated with the geographic location based at least in part on metadata associated with the photographic images.

6. The method of claim 5, wherein identifying photographic images associated with the geographic location comprises identifying photographic images that are associated with a geographic location within a threshold distance of the geographic location of the photographic tour.

7. The method of claim 5, wherein the metadata comprises a geotag.

8. A computer-implemented method, comprising:
displaying, at a client device associated with a user, a map indicating a geographic location;
receiving, from a server, data identifying a plurality of photographic images to which the user has access rights, the plurality of photographic images identified by the server as being associated with the geographic location;
displaying, on the map, a plurality of graphical representations, each graphical representation corresponding to one of the photographic images;
receiving input selecting a plurality of the graphical representations; and
sending, by the client device, a request to the server to generate a photographic tour of the geographic location, the tour comprising the photographic images corresponding to the plurality of graphical representations selected.

9. The method of claim 8, further comprising receiving data from the server in response to the request and using the received data to display the tour at the client device.

10. The method of claim 8, wherein the plurality of graphical representations displayed on the map comprises:
at least one representation corresponding to an image to which the user has an access control right, and
at least one representation corresponding to an image to which the user does not have an access control right but to which the user has been granted access by a second user that does have an access control right.

11. The method of claim 8, further comprising receiving input specifying a sequence for displaying the photographic images corresponding to the plurality of the graphical representations selected, the tour comprising the photographic images corresponding to the plurality of graphical representations selected being displayed in accordance with the sequence specified.

12. The method of claim 8, further comprising receiving data from the server in response to the request and using the received data to display the tour at the client device, the displayed tour comprising an animation of the photographic images corresponding to the plurality of graphical representations selected being displayed in accordance with the sequence specified.

13. A non-transitory computer readable medium comprising program instructions stored thereon that are executable by a processor to cause the following steps for generating a photographic tour of a geographic location:
determining that a first set of photographic images administered by a first user are associated with the geographic location;
defining a second set of photographic images, each photographic image of the second set being: (i) associated with the geographic location and (ii) an image to which the first user has been granted an access right;
providing data usable to display a representation of the photographic images of the first and second sets of photographic images on a display device;
receiving, data indicating a selection of two or more of the photographic images of the first and second sets of images, wherein the two or more photographic images selected comprise at least one of the photographic images of the first set of photographic images and at least one of the photographic images of the second set of photographic images; and
generating a photographic tour of the geographic location comprising the two or more photographic images.

14. The medium of claim 13, wherein the photographic tour of the geographic location comprises photographic images of the geographic location taken from different perspectives.

15. The medium of claim 13, wherein the data indicating a selection of two or more of the photographic images of the first and second sets also indicates a specified sequence to be used in generating the photographic tour.

16. The medium of claim 13, wherein determining and defining are based at least in part on metadata associated with the photographic images.

17. The medium of claim 16, wherein the photographic images of the first and second sets of photographic images are determined to be associated with the geographic location based at least in part on their being associated with a location proximate to the geographic location.

18. The medium of claim 16, wherein the photographic images of the first and second sets of photographic images are determined to be associated with the geographic location based at least in part on a geographic metadata for each of the images corresponding to a geographic location within a threshold distance of the geographic location.

19. The medium of claim 18, wherein the geographic metadata comprises a geotag.

20. The medium of claim 13, wherein providing data usable to display a representation of the photographic images of the first and second sets of photographic images on a display device comprises providing data that causes a device receiving the data to display icons corresponding to the photographic images on a map.
